(19) United States
(12) Patent Application Publication
(10) Pub. No.: US 2026/0065096 A1
(43) Pub. Date: Mar. 5, 2026

(54) SYSTEM AND METHOD FOR PROVIDING A DATA MODELING ASSISTANT FOR USE WITH A DATA ANALYTICS ENVIRONMENT

(71) Applicant: ORACLE INTERNATIONAL CORPORATION, Redwood Shores, CA (US)

(72) Inventors: Glenn Murray, Boulder, CO (US); Xuehong Zhou, Redwood City, CA (US); Luis Rivas, Denver, CO (US); Nikhil Surve, San Ramon, CA (US)

(21) Appl. No.: 19/301,438

(22) Filed: Aug. 15, 2025

Related U.S. Application Data
(60) Provisional application No. 63/690,562, filed on Sep. 4, 2024.

(51) Int. Cl. G06N 5/04

(52) U.S. Cl. CPC G06N 5/04

(57) ABSTRACT

Embodiments described herein are generally related to data analytics environments, and are particularly directed to systems and methods for use with a data analytics environment to provide a data modeling assistant for use with the data analytics environment. A method can provide, by a computer including one or more processors, access to a data analytics environment. The method can receive, at the data analytics environment, an instruction to ingest a first dataset, the first data set being retrieved from a computing device or from a storage accessible by the data analytics environment. The method can semantically profile, during the data analytics environment and during ingestion of the first dataset, the first dataset to generate a set of metrics and metadata associated with the first dataset. The method can generate a recommendation for the first dataset.

### CLAIM OF PRIORITY AND CROSS-REFERENCE TO RELATED APPLICATIONS

This application claims the benefit of priority to U.S. Provisional patent application titled “SYSTEM AND METHOD FOR PROVIDING A DATA MODELING ASSISTANT FOR USE WITH A DATA ANALYTICS ENVIRONMENT”, Application No. 63/690,562, filed Sep. 4, 2024; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for use with a data analytics environment to provide a data modeling assistant for use with the data analytics environment.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

### SUMMARY

Embodiments described herein are generally related to data analytics environments, and are particularly directed to systems and methods for use with a data analytics environment to provide a data modeling assistant for use with the data analytics environment.

In accordance with an embodiment, a method for use with a data analytics environment to provide a data modeling assistant for use with the data analytics environment can be provided. A method can provide, by a computer including one or more processors, access to a data analytics environment. The method can receive, at the data analytics environment, an instruction to ingest a first dataset, the first data set being retrieved from a computing device or from a storage accessible by the data analytics environment. The method can semantically profile, during the data analytics environment and during ingestion of the first dataset, the first dataset to generate a set of metrics and metadata associated with the first dataset. The method can, based upon a comparison of the generated set of metrics and metadata associated with the first dataset with a plurality of pre-existing datasets, generate, by the data analytics environment, a recommendation for the first dataset.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 illustrates an example use of a data modeling assistant with a data analytics environment, in accordance with an embodiment.

FIG. 10A further illustrates an example use of a data modeling assistant with a data analytics environment, in accordance with an embodiment.

FIG. 10B further illustrates an example use of a data modeling assistant with a data analytics environment, in accordance with an embodiment.

FIG. 10C further illustrates an example use of a data modeling assistant with a data analytics environment, in accordance with an embodiment.

FIG. 11 illustrates an example flow diagram for use of a data modeling assistant with a data analytics environment, in accordance with an embodiment.

FIG. 12 is a screenshot of a data modeling assistant for use with a data analytics environment, in accordance with an embodiment.

FIG. 13 is a screenshot of a data modeling assistant for use with a data analytics environment, in accordance with an embodiment.

FIG. 14 is a screenshot of a data modeling assistant for use with a data analytics environment, in accordance with an embodiment.

FIG. 15 is a screenshot of a data modeling assistant for use with a data analytics environment, in accordance with an embodiment.

FIG. 16 is a screenshot of a data modeling assistant for use with a data analytics environment, in accordance with an embodiment.

FIG. 17 illustrates a flowchart of a method for use with a data analytics environment to provide a data modeling assistant for use with the data analytics environment, in accordance with an embodiment.

FIG. 18 further illustrates an example data analytics environment, including the use of a large language model, in accordance with an embodiment.

FIG. 19 further illustrates an example data analytics environment, including the use of retrieval-augmented generation, in accordance with an embodiment.

FIG. 20 illustrates a flowchart of a method for use with a data analytics environment to provide a data modeling assistant for use with the data analytics environment, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

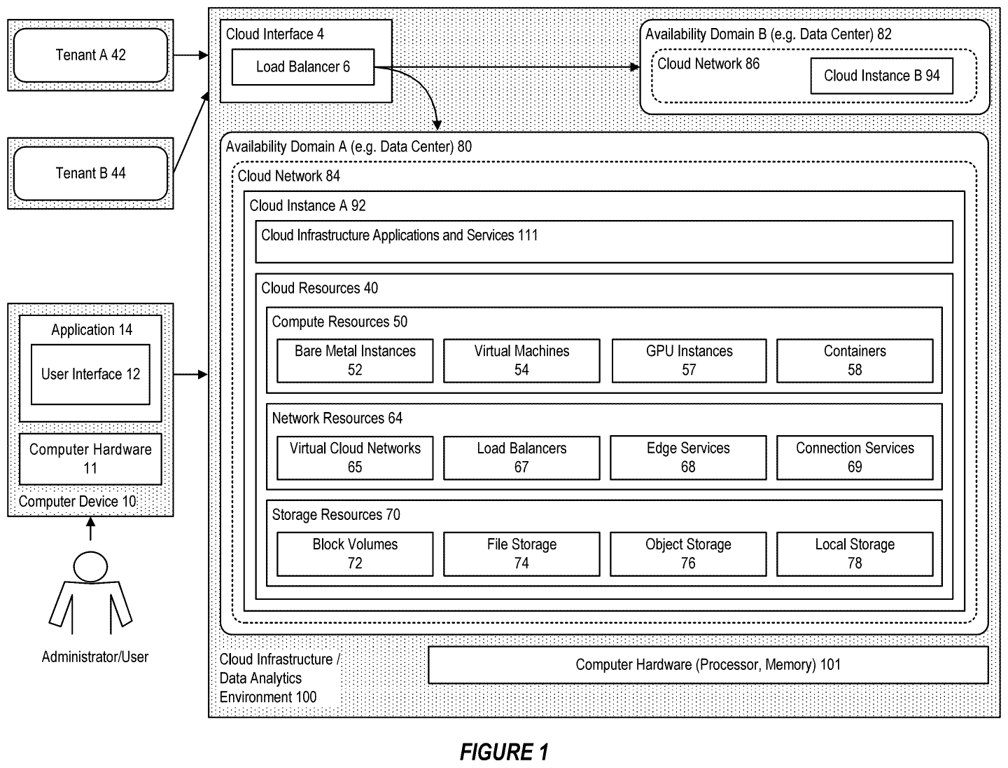

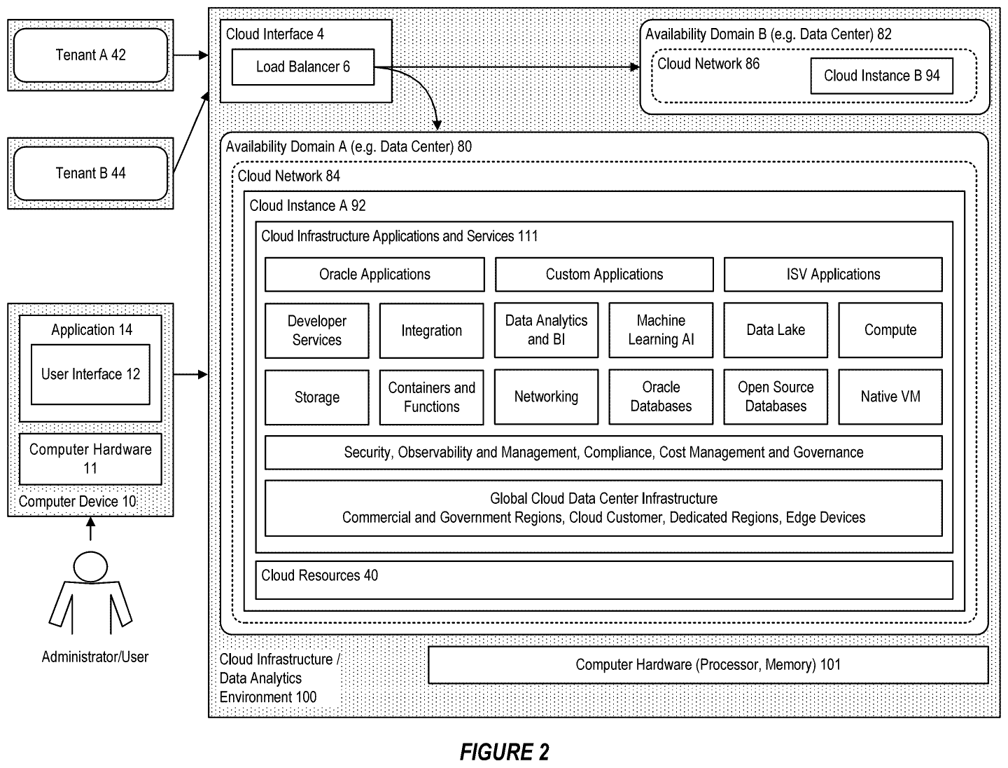

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

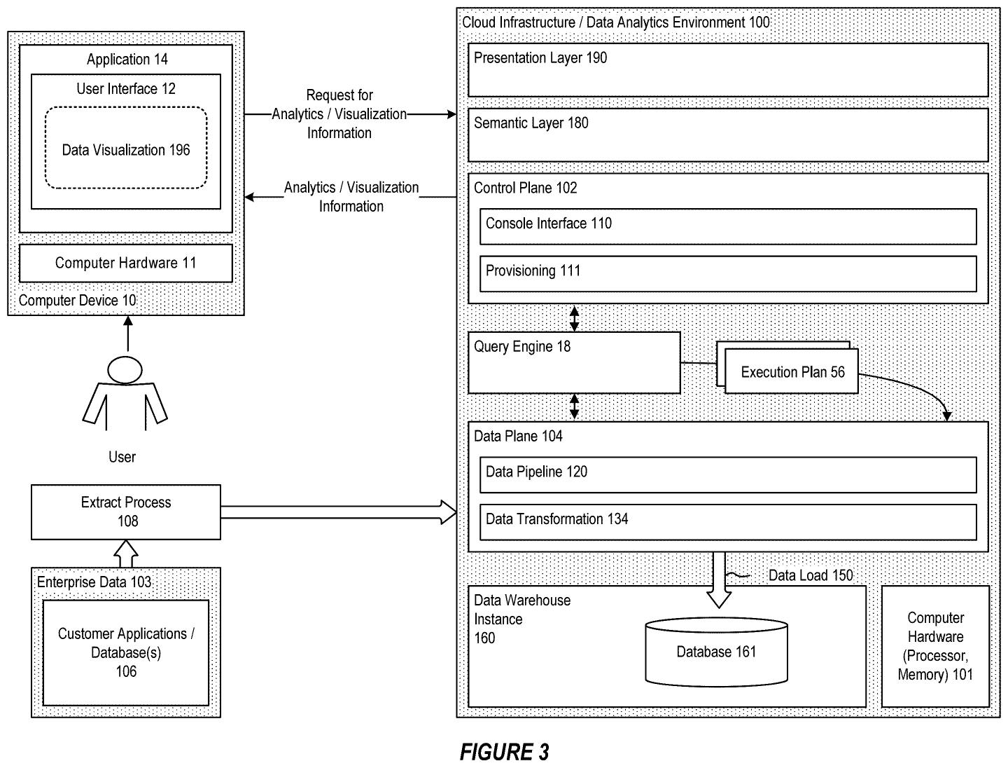

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer 270 to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

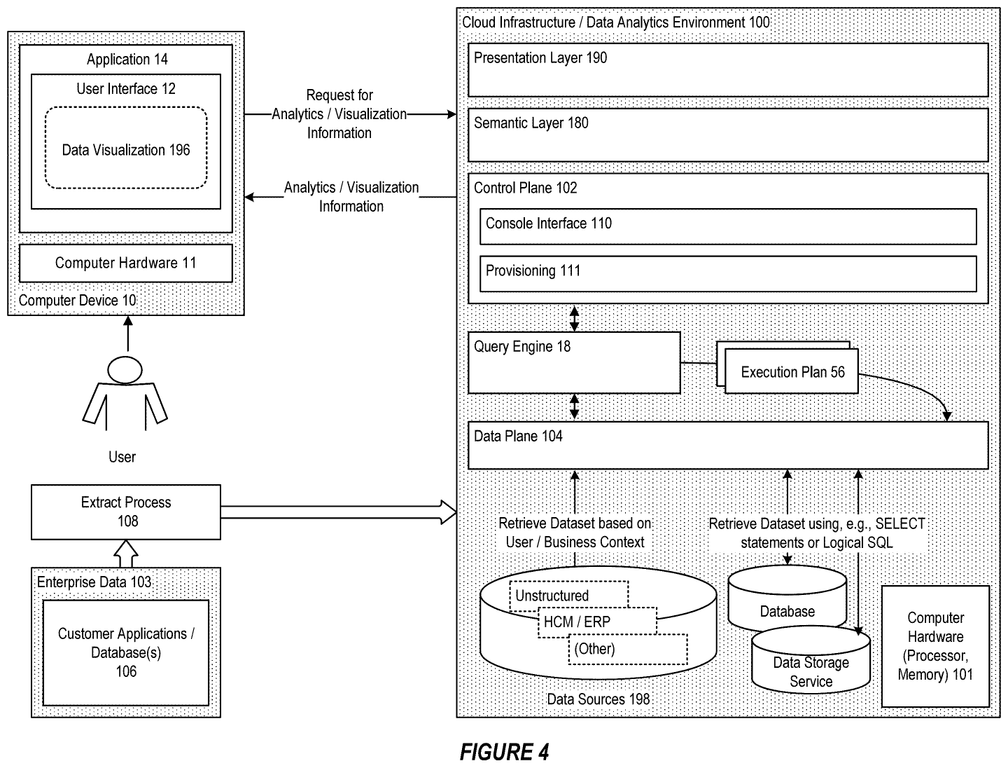

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

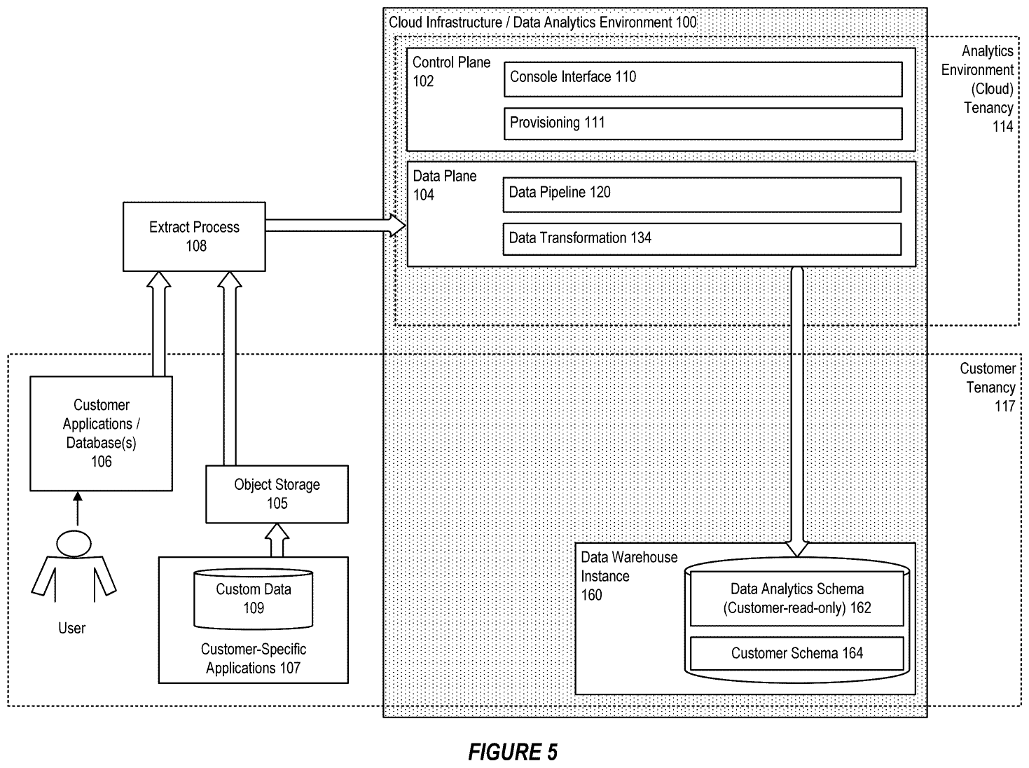

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

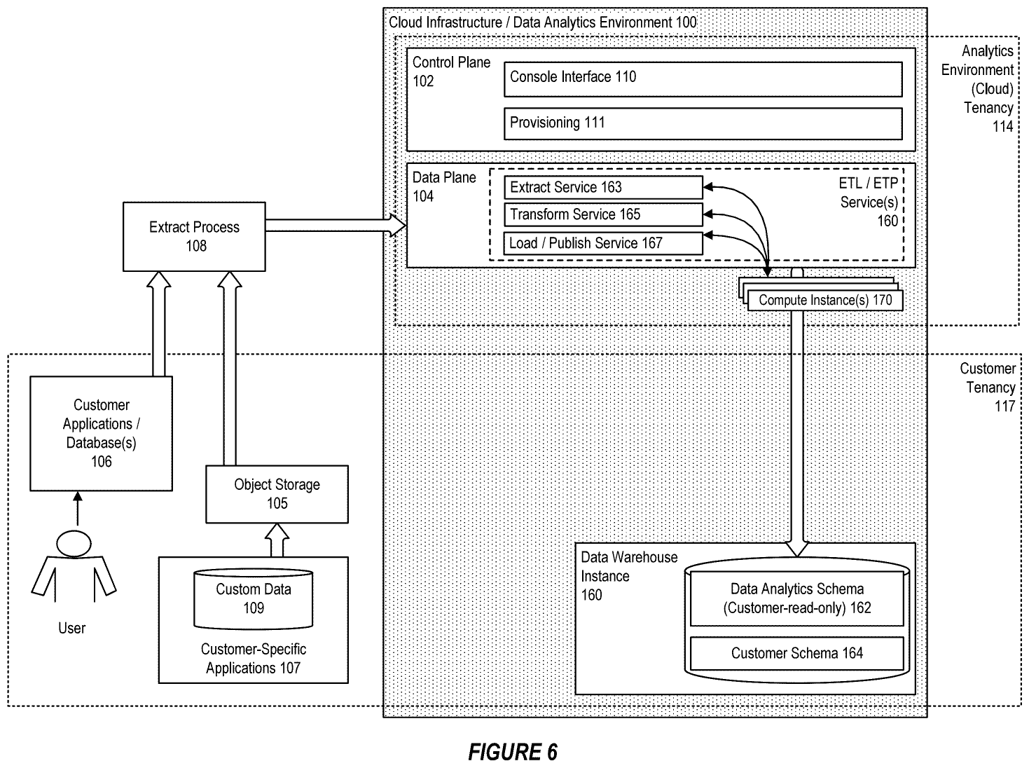

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

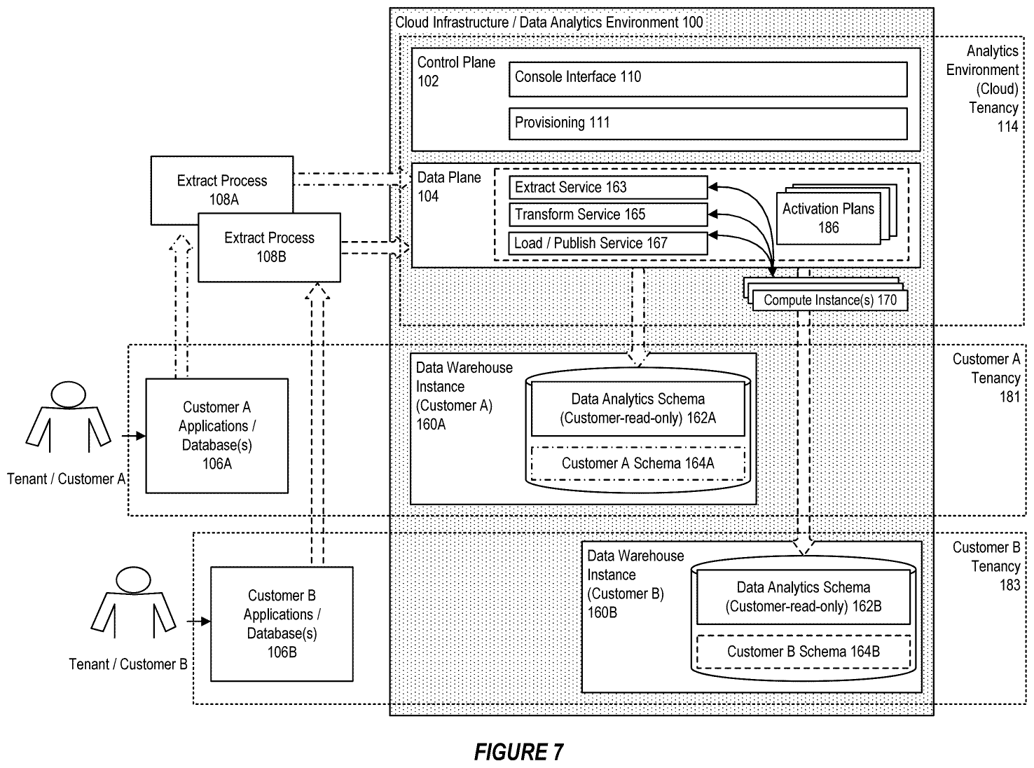

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

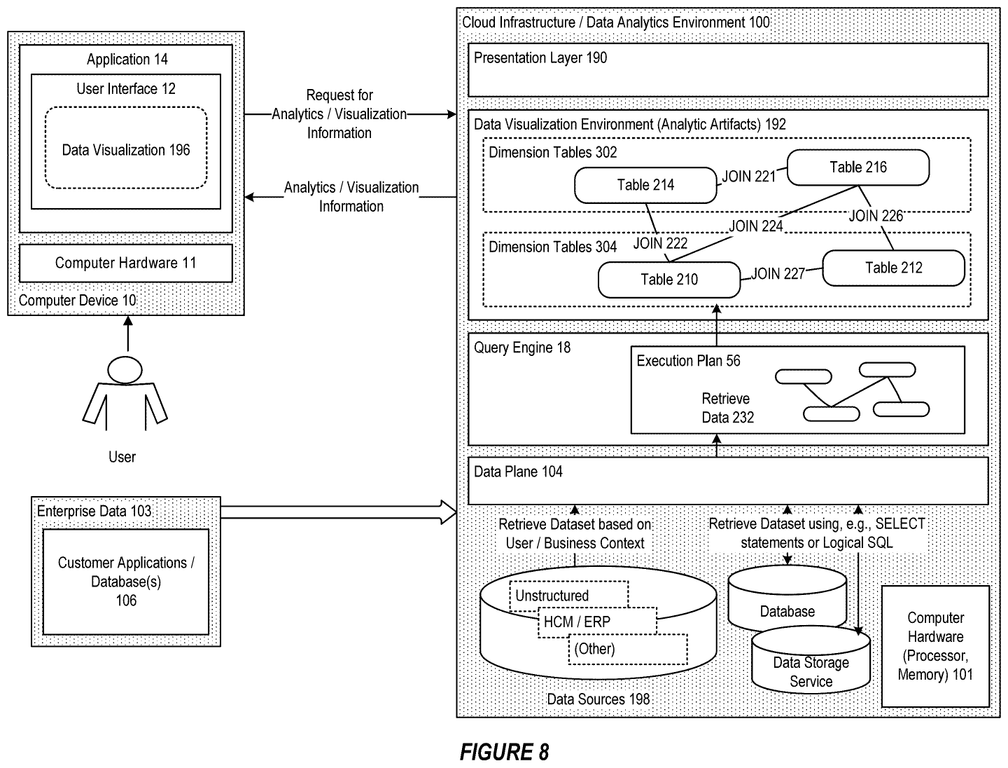

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Data Modeling Assistant

In currently available business intelligences systems, an authoring end-user spends a fair bit of time picking the correct tables to join using the correct set of join column keys and then curating their dataset metadata with the Prep steps. This process requires a business user to have a fair bit of schema knowledge (e.g., database schema). Users also need know-how of systems grammar in case new calculated column(s) are added. Duplicate datasets get created easily since there is no warning for the same during dataset creation process. It is easy to add similar sounding/looking schema table to BI dataset, but there is no automated way of knowing existence of similar tables in same/multiple schemas.

In accordance with an embodiment, the systems and methods described herein provide real-time recommendations that enable users of datasets to prevent dataset duplication (duplication prevention), re-use work that has been done previously (similar tables), and assistance with what other tables to join with (join recommendations).

In accordance with an embodiment, the systems and methods provided herein address a two-fold problem. The proliferation of duplicate datasets, created as users use the same datasets for visualizations. This poses a significant challenge in analytic platforms, as they lead to data redundancy, increased storage requirements, and potential inconsistencies in analytical results. Second, finding and modifying appropriate datasets is a time-consuming task that can be alleviated, with the described systems and methods, by reusing already existing modification scripts and identifying similar datasets to ones under construction.

In accordance with an embodiment, the systems and methods described herein address gaps in the following four areas:

Duplicate Dataset/s detection across “all” the users-During dataset authoring flow, the systems and methods can identify and prompt pre-existing dataset/s based on the decision tree algorithm based on certain heuristics. Names of duplicate datasets can be partially obfuscated if current user doesn't have access to them (dataset owner will still be visible). This will encourage dataset reuse, thus avoiding duplicate dataset creation during authoring process.

Recommend additional/new join tables—the systems and methods can recommend new tables that can be joined based on the current set of tables already present on the canvas. This is powered by heuristically driven decision tree algorithm. This can encourage right set of tables getting added to data model from the sea of similar sounding tables across multiple schemas.

Recommend alternative versions of current table/s in canvas—similar to new table recommendation, the systems and methods can also recommend replacement of the currently/manually added tables in the canvas.

Ability for importing prep steps along with the recommended tables—end user can have options for importing previously done BI prep steps along with the recommended table that is getting imported. This is possible because prep steps are persisted in BI dataset metadata that wraps underneath remote table.

In accordance with an embodiment, the disclosed systems and methods comprises an implementation of a process designed to harness metrics and metadata (also referred to as “column fingerprints”), generated through semantic profiling during data ingestion. This process can compare incoming data with column fingerprints of pre-existing datasets (e.g., all or some) within the system to provide similarity scores. Upon detecting a match (e.g., a similarity score above a certain threshold), a notification can be triggered to inform users about the discovery of another dataset or dataset table that is similar to the one just ingested. In some embodiments, there can be provided a process to deal with multiple matches and ambiguities. A set of heuristics, such as dataset participation in workbooks, number of transformations, number of shares, etc., can be utilized to create a Data Value Index (DVI), which can be utilized to assist in breaking ties between datasets.

In accordance with an embodiment, a notification in a dataset editor can be utilized in conjunction with real-time recommendations to present users a set of options to choose from, including the ability to prevent dataset duplication (duplication prevention), re-use work that has been done previously (similar tables), selection additional tables to join with a current dataset (join recommendations), ignore the discovered datasets, abort the ingestion process, or opt to utilize the discovered dataset along with or without its existing transforms. Additionally, options can be generated to present to users to allow a choice to initiate a dataset creation process using the newly found dataset and its corresponding transform script. This multifaceted approach addresses the dual challenges identified above: firstly, it significantly mitigates redundancy in the system by identifying and preventing the incorporation of duplicate datasets; secondly, it actively guides and encourages users to embrace the practice of reusing established datasets along with their proven transforms and enrichments.

In accordance with an embodiment, the systems and methods provided herein automates and streamlines the process of creating datasets used for visualizations (e.g., in Oracle Analytics Cloud (OAC)), making analytic platforms available to more users and making existing users better informed and more productive.

In accordance with an embodiment, the data modeling assistant can allow a user to build a data model. A database can comprise a collection of tables that provide information on topics, such as customer names, orders . . . , etc. When a user creates a data model, the user can input instructions to connect-up various tables to provide relevant data or information for visualizations. The system and methods described herein provide an assistant for the user in gathering the information from the various tables to create data models and generate visualizations.

In accordance with an embodiment, the systems and methods described provide a data modeling assistant that provides suggestions or recommendations or scored lists based on previous data models that have been developed. These recommendations can then be presented to a user, e.g., via a graphical user interface, and the user can look through the list and pick and choose from there. The user can select one or more of the recommended data models and use that model to build their environment and data visualizations. This then allows the user to (a) create a new data model, or (b) reuse a data model for new purposes.

In accordance with an embodiment, the systems and methods provide a user with selectable options for an existing dataset that they can then modify to suit their needs. This provides for duplication avoidance by, for example, providing recommended joins, or other actions, from prior uses, including enrichments, transforms, etc.

In accordance with an embodiment, the system and methods can determine and/or score a popularity or ranking of a dataset and generate a ranked score or result that provides the user with that a “ranking” information. The scoring can take into account dataset or table similarity, as well as, for example, the expertise level or score of a user who made the dataset. This provides a system intelligence to how to rank the datasets.

In accordance with an embodiment, datasets can be associated with preparation (prep) steps which are enrichments and transformations to an underlying set of data—for example, column names and additional information as to how to use those tables. A table can be associated with a metadata that instructs how the data is transformed or enriched when used in a dataset. For example, a table of data could actually end up as two different datasets because they have different enrichments and transformations.

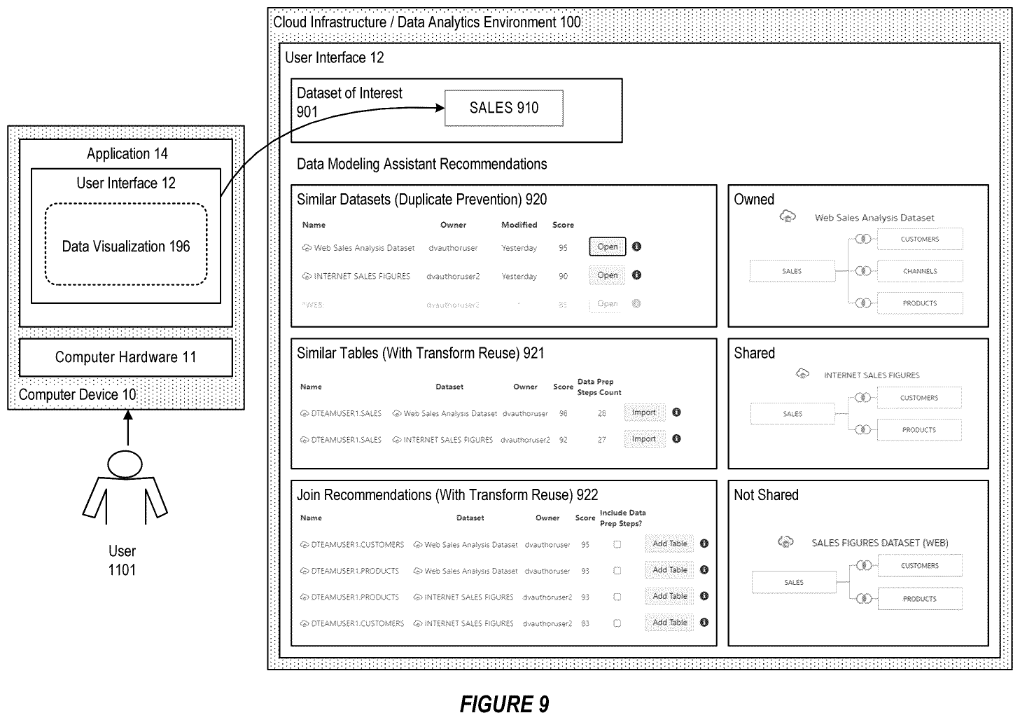

FIG. 9 illustrates an example use of a data modeling assistant with a data analytics environment, in accordance with an embodiment.

In accordance with an embodiment, a user 1101, such as an authorized user, can interact with a client computing device 10 to, via a data visualization 196, drag a sales table 910 onto a canvas as a dataset of interest 901.

In accordance with an embodiment, a data modeling assistant can, upon detecting the table being dragged into the dataset of interest, identify the table of interest as a sales table, and provide an exemplary data model that utilizes sales tables.

In accordance with an embodiment, alternatively, the data modeling assistant can provide a data model that utilizes a similar dataset 920. When utilizing a similar dataset, this can provide for mitigation of duplication of datasets.

In accordance with an embodiment, in another window 921, the data modeling assistant can, via a data prep step, provide suggestions for similar tables which indicate how, and to what extent, the similar data table has been modified with enrichments. This information can be presented.

In accordance with an embodiment, at a third window 922, the data modeling assistant can display join recommendations based upon the sales data 910 being dragged onto the canvas.

In accordance with an embodiment, a table, such as sales 910, when dragged onto a canvas can be converted to a dataset. The dataset can be then enriched further with other tables, joins, transformations, etc. to other datasets, and displayed the UI as recommendations.

In accordance with an embodiment, when a dataset is brought in, the systems and methods can bring the enrichments, but when the systems and methods bring a table, the systems and methods can bring just that table for further use (i.e., bringing over the data prep steps is optional). From there, the data modeling assistant and/or the user can decide to add further joins or recommendations. The joins are part of the data authoring process, not necessarily the enrichments.

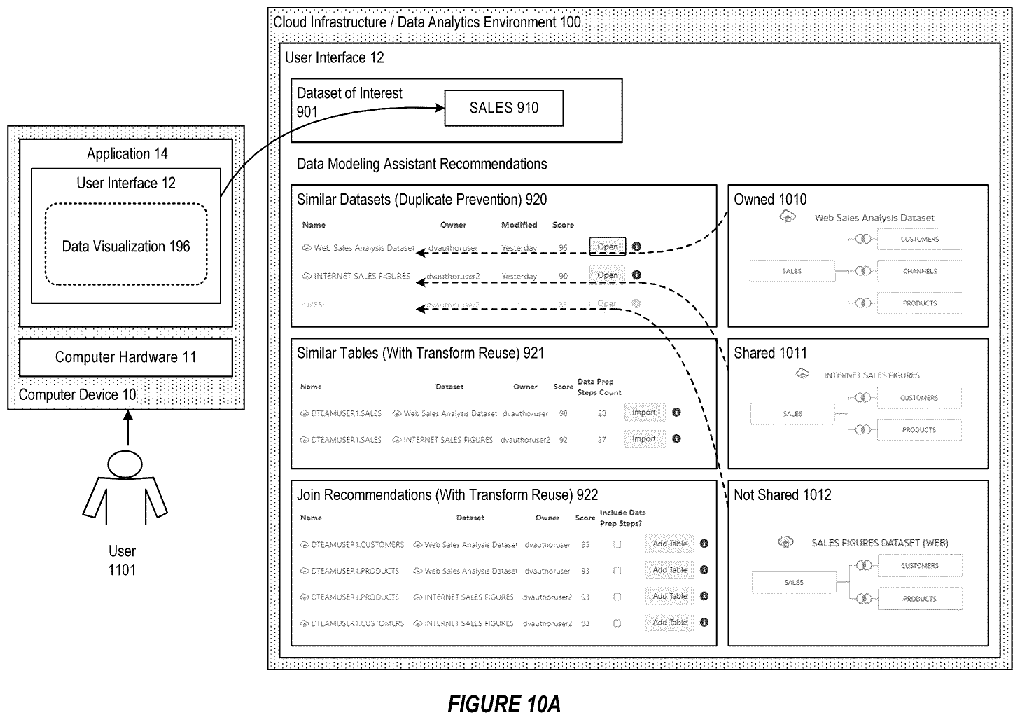

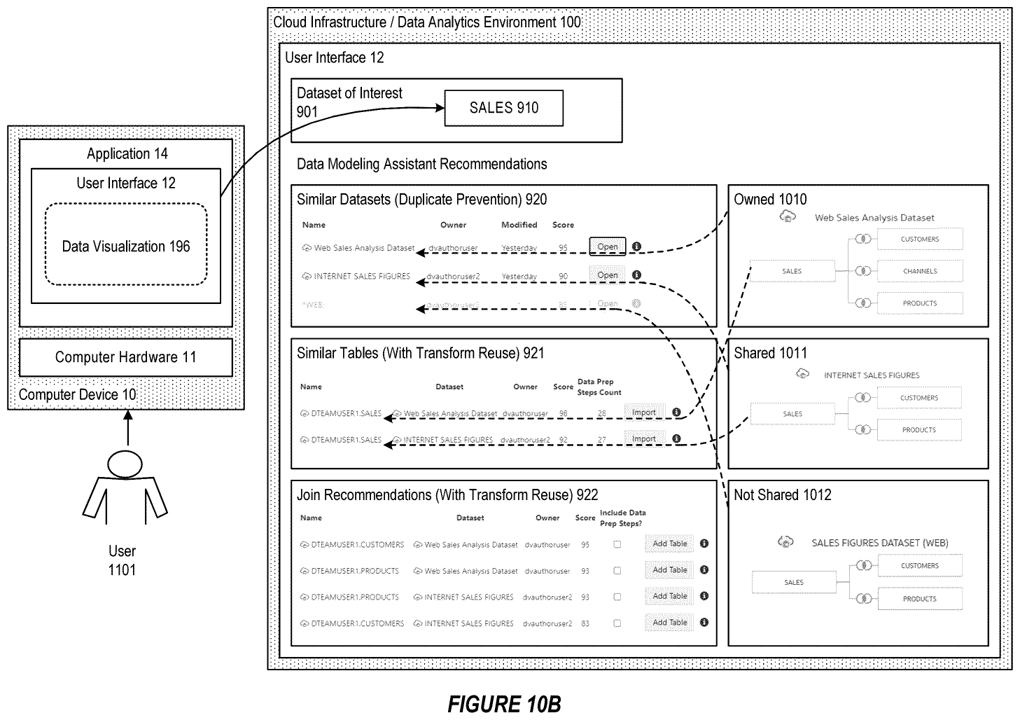

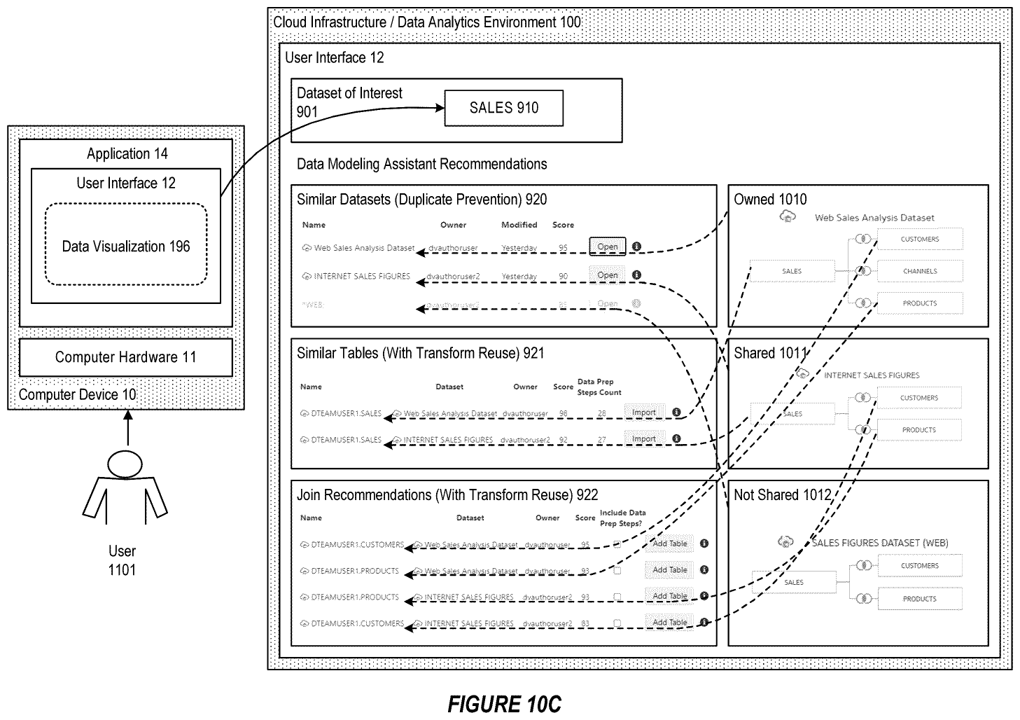

FIG. 10A-10C further illustrates an example use of a data modeling assistant with a data analytics environment, in accordance with an embodiment.

In accordance with an embodiment, FIGS. 10A-10C illustrate exemplary UIs produced, at least in part, by the described data modeling assistant.

In accordance with an embodiment, in the illustrated example, a user has dragged the SALES table from a data store into a canvas. On the first window, 920, the data modeling assistant can display similar datasets table similarity that look at various characteristics, similar columns names etc—to determine whether the table or dataset are similar. The similarity can look at multiple tables or datasets (e.g., owned 1010, shared 1011, or not shared 1012) to figure similarity. As displayed, similar datasets presented by the data modeling assistant can be owned (e.g., by the user), shared with the user, or not shared with the user.

In accordance with an embodiment, the data modeling assistant can determine weights associated with comparing tables and then use these weights to determine scores. For example, emails may be exact match in different tables so there is a high score. Because the data modeling assistant looks at many tables (e.g., owned 1010, shared 1011, and not shared 1012), the assistant can have a set threshold which the similarity comparison needs to exceed before the table or dataset is presented to the user.

In accordance with an embodiment, as depicted by FIGS. 10A, 10B, and 10C, the windows that are populated by the data modeling assistant (e.g., windows 920, 921, and 922) can be populated by data that is owned 1010 by the user, shared 1011 with the user, or not shared 1012 by the user.

In accordance with an embodiment, the systems and methods can look for features (aka “fingerprints”) to provide an indication of which tables are similar.

In accordance with an embodiment, the systems and methods described herein can utilize a large learning model (LLM) in order to perform functions such as, creating enrichment and transformation scripts, which can be utilized by the user or additional users with respect to selected data tables or datasets.

In accordance with an embodiment, the generation of fingerprints and re-use of user knowledge can be performed in real time, that is, when the datasets are created, the systems and methods can profile them to create/generate fingerprints of the dataset. This is possible when the systems and methods deal with metadata of the tables of the dataset, and not the actual data of the datasets. The metadata is managed at the data prep layer.

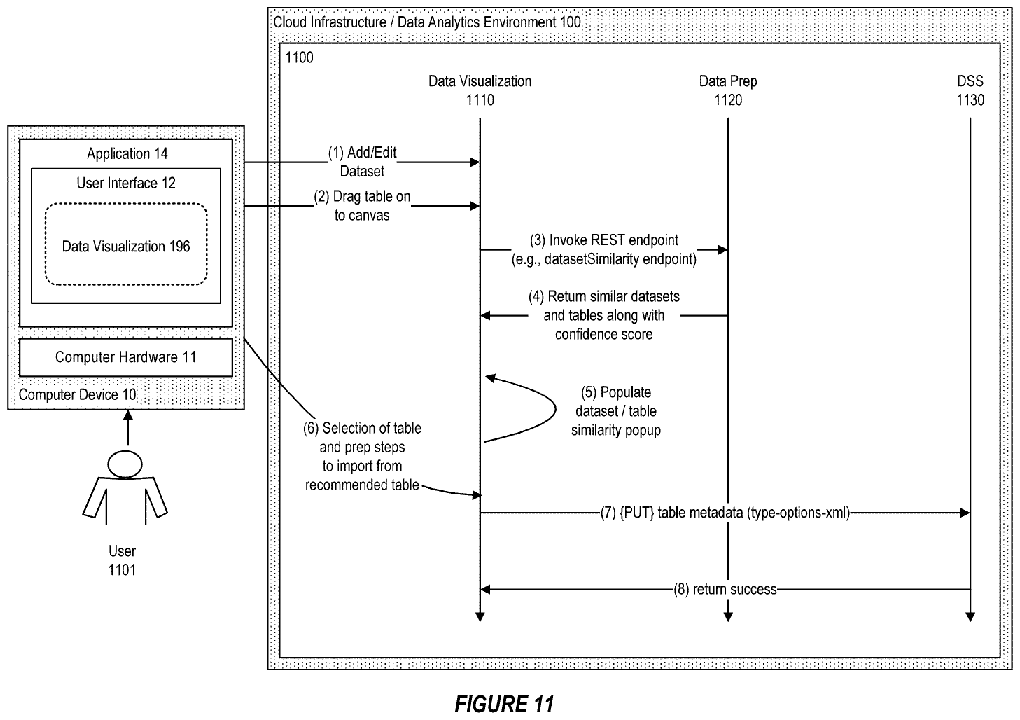

FIG. 11 illustrates an example flow diagram for use of a data modeling assistant with a data analytics environment, in accordance with an embodiment.

In accordance with an embodiment, shown in FIG. 11 are a user 1101 interacting with a computer device 10. The computer device, which can comprise, for example, a client device, such as, for example, can comprise device hardware 11 (e.g., processor, memory), application 14 and user interface 12 (e.g., graphical user interface), which can enable an administrator other user to communicate with the cloud infrastructure environment via a network such as, for example, a wide area network, local area network, or the Internet, to create or update cloud services. Communication with the data analytics environment 100 can result in a data visualization 196.

In accordance with an embodiment, a user/author 1101, can, at 1, add or edit a dataset via a data visualization environment (DV) 1110. By adding a dataset, a dataset not previously at the data analytics environment can be uploaded, linked to, or otherwise imported or sent to the data analytics environment. By editing a dataset, a dataset already existing at the data analytics environment can be edited, e.g., by instructions received at the data analytics environment from the computer device 10.

In accordance with an embodiment, the user/author can, at 2, drag a table into a canvas within the DV environment 1110. This signals the DV environment of a table which the user/author would like to work on.

In accordance with an embodiment, at 3, the systems and methods can automatically invoke a dataset similarity REST endpoint at a data prep environment 1120. The data prep environment 1120 can, at 4, return to the DV environment 1110 determined similar datasets and tables along with a generated confidence score associated with each returned similar dataset and table.

In accordance with an embodiment, the DV environment 1110 can, at 5, populate a display showing table similarity (e.g., via a popup). The DV environment can do so for each returned dataset and table determined by the data prep environment. These, e.g., popup displays can be generated and transmitted to the computer device for display at the user interface 12. At 6, the systems and methods can receive, from the computer device, an indication of a selection of one or more of the recommended tables and prep steps to import from the recommended table.

In accordance with an embodiment, the DV environment 1110 can communicate, at 7, with a Decision Support System (DSS) 1130 to put table metadata. At 8, the DSS can return success to the DV environment.

In accordance with an embodiment, datasets can be associated with preparation (prep) steps which are enrichments and transformations to an underlying set of data—for example, column names and additional information as to how to use those tables. A table can be associated with a metadata that instructs how the data is transformed or enriched when used in a dataset. For example, a table of data could actually end up as two different datasets because they have different enrichments and transformations. The DSS (dataset services layer) can interact with the database, this is where the metadata is stored. The Dataprep layer acts between the users and the database to generate the recommendations.

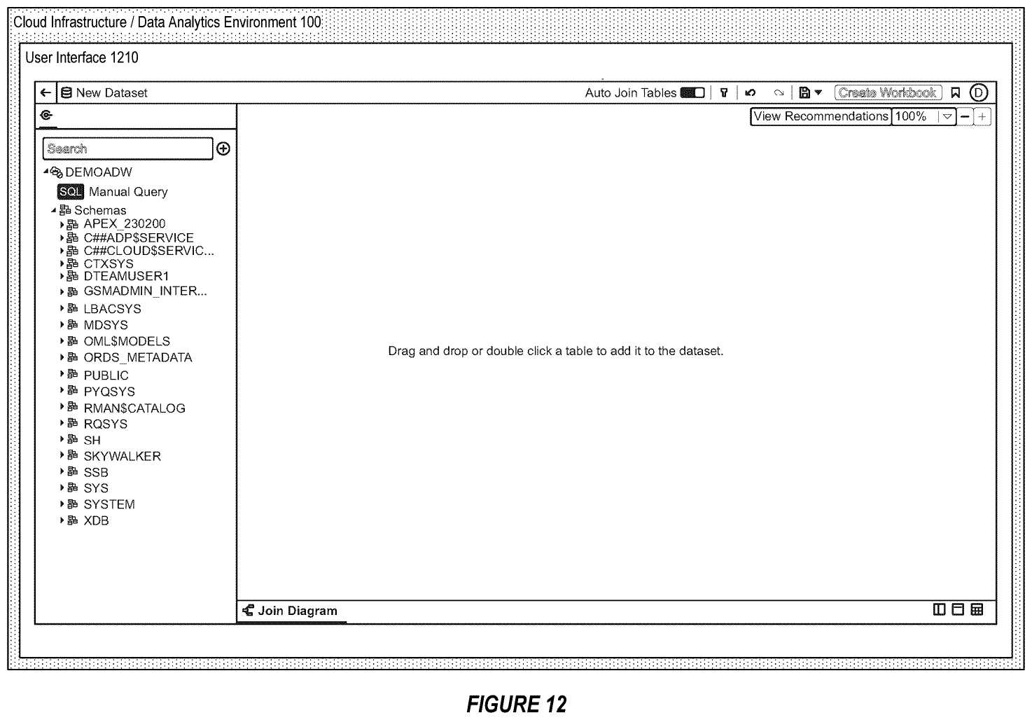

FIG. 12 is a screenshot of a data modeling assistant for use with a data analytics environment, in accordance with an embodiment.

In accordance with an embodiment, FIG. 12 shows a canvas of a data visualization environment where a user can drag and drop a selected dataset from the left column.

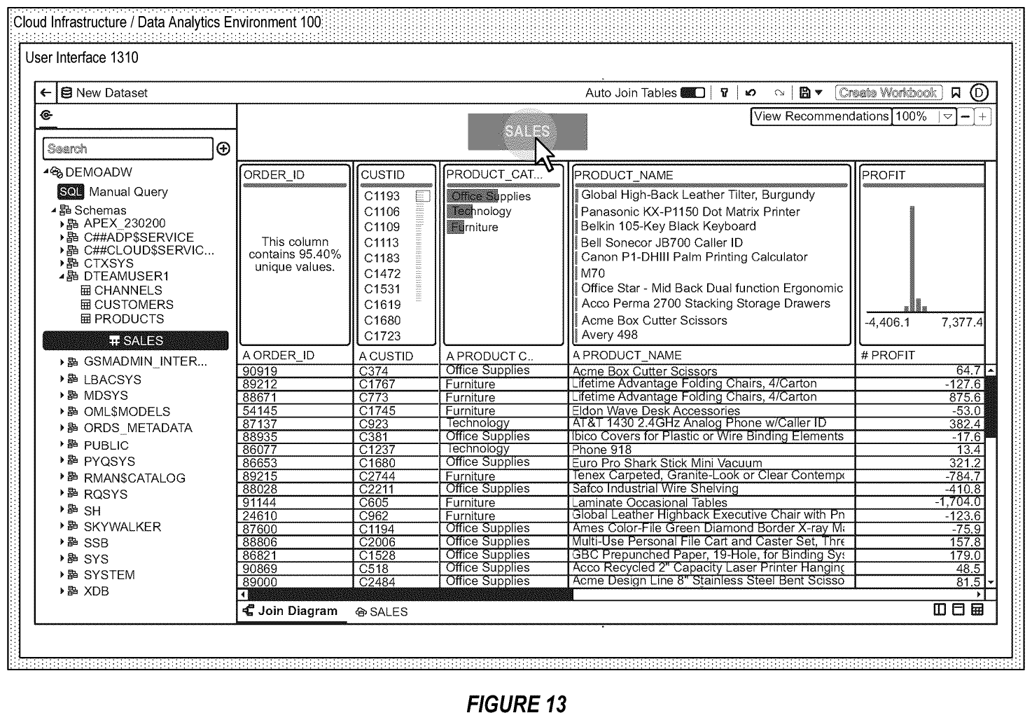

FIG. 13 is a screenshot of a data modeling assistant for use with a data analytics environment, in accordance with an embodiment.

In accordance with an embodiment, FIG. 13 shows a canvas of a data visualization environment where a user has selected a dataset and has dragged it into the previously blank canvas.

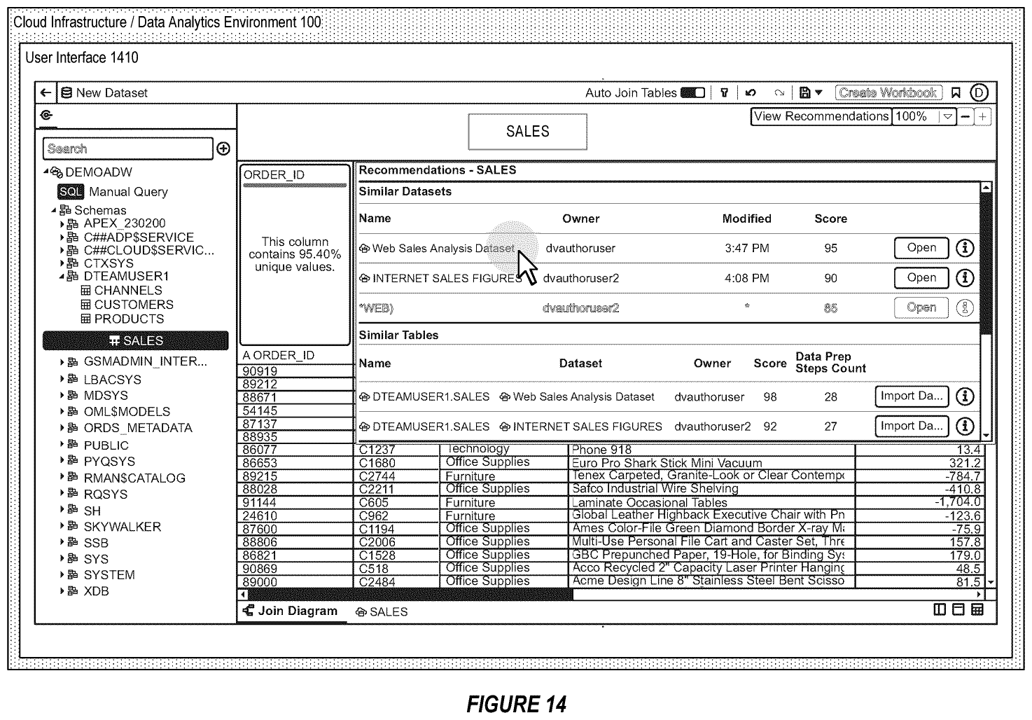

FIG. 14 is a screenshot of a data modeling assistant for use with a data analytics environment, in accordance with an embodiment.

In accordance with an embodiment, FIG. 14 shows a canvas of a data visualization environment where a user has selected a dataset and has dragged it into the previously blank canvas. FIG. 14 additionally shows recommended datasets and tables that can be joined or utilized by the author/user of the data visualization environment. These include similar datasets as well as similar tables. Displayed therewith are associated owners of the recommended joins as well as similarity scores.

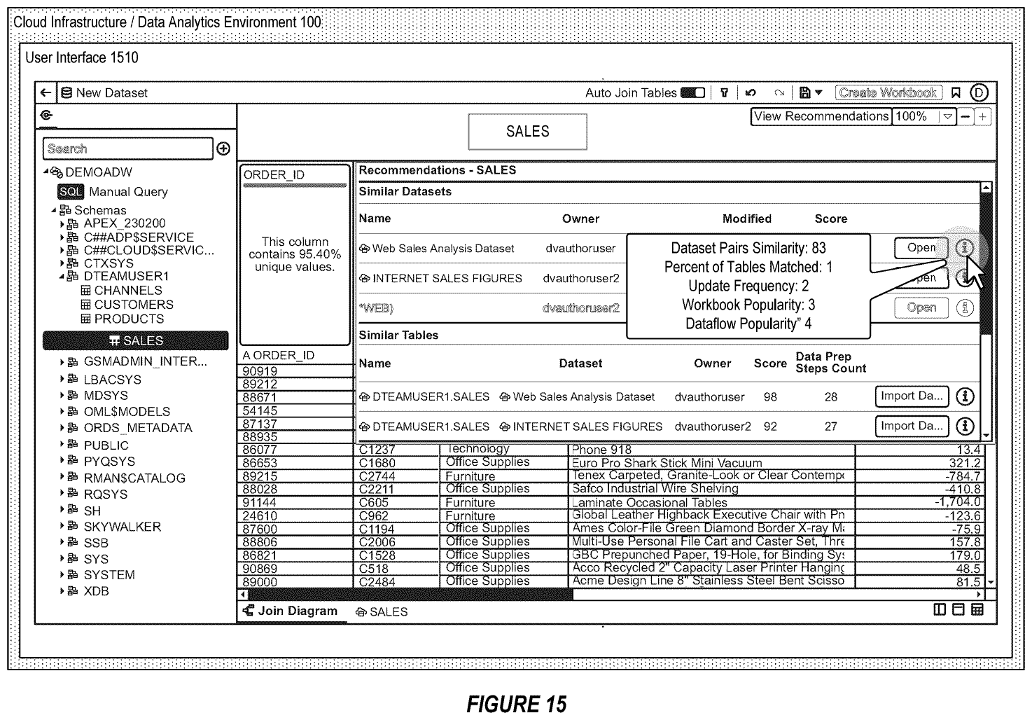

FIG. 15 is a screenshot of a data modeling assistant for use with a data analytics environment, in accordance with an embodiment.

In accordance with an embodiment, FIG. 15 shows a canvas of a data visualization environment where a user has selected a dataset and has dragged it into the previously blank canvas. FIG. 15 additionally shows recommended datasets and tables that can be joined or utilized by the author/user of the data visualization environment. These include similar datasets as well as similar tables. Displayed therewith are associated owners of the recommended joins as well as similarity scores. FIG. 15 further shows details associated with one of the similar datasets, including various points used in generating the similarity score.

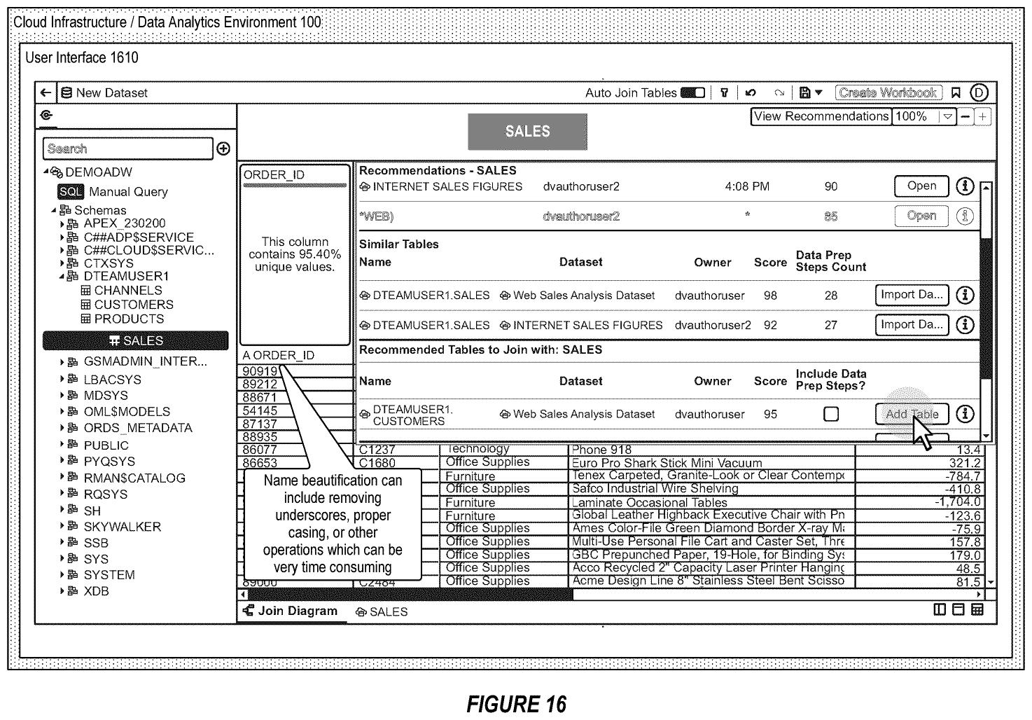

FIG. 16 is a screenshot of a data modeling assistant for use with a data analytics environment, in accordance with an embodiment.

In accordance with an embodiment, FIG. 16 shows a canvas of a data visualization environment where a user has selected a dataset and has dragged it into the previously blank canvas. FIG. 16 additionally shows recommended datasets and tables that can be joined or utilized by the author/user of the data visualization environment. These include similar datasets as well as similar tables. Displayed therewith are associated owners of the recommended joins as well as similarity scores. FIG. 16 further shows an option to port over data preparation steps that have previously been performed in the recommended joins for similar data tables. Porting over these data preparation steps (e.g., formatting data in certain columns) can be very beneficial.

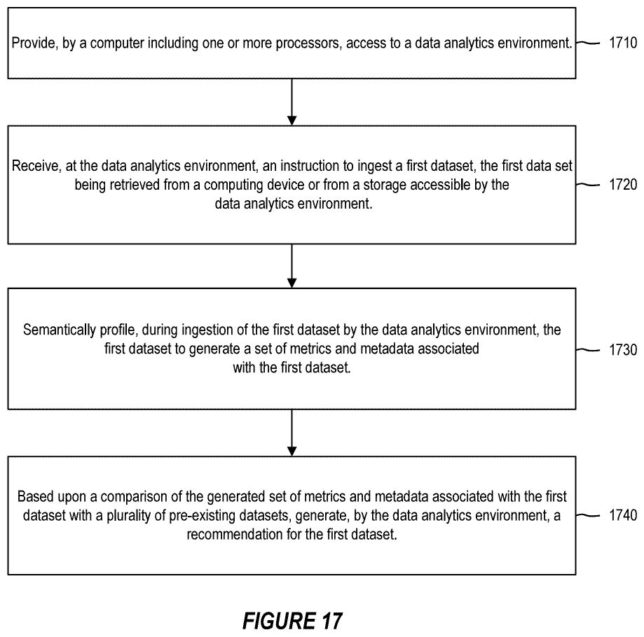

FIG. 17 illustrates flowchart of a method for use with a data analytics environment to provide a data modeling assistant for use with the data analytics environment, in accordance with an embodiment.

In accordance with an embodiment, at step 1710, the method can provide, by a computer including one or more processors, access to a data analytics environment.

In accordance with an embodiment, at step 1720, the method can receive, at the data analytics environment, an instruction to ingest a first dataset, the first data set being retrieved from a computing device or from a storage accessible by the data analytics environment.

In accordance with an embodiment, at step 1730, the method can semantically profile, during the ingestion of the first dataset by the data analytics environment, the first dataset to generate a set of metrics and metadata associated with the first dataset.

In accordance with an embodiment, at step 1740, the method can, based upon a comparison of the generated set of metrics and metadata associated with the first dataset with a plurality of pre-existing datasets, generate, by the data analytics environment, a recommendation for the first dataset.

In accordance with an embodiment, the systems and methods provided herein can also be used with or incorporate techniques for determining similarities or relationships between dataset or tables, or facilitating joining of datasets, as described for example in U.S. Pat. No. 11,704,321, titled “TECHNIQUES FOR RELATIONSHIP DISCOVERY BETWEEN DATASETS”; U.S. Pat. No. 11,379,506, titled “TECHNIQUES FOR SIMILARITY ANALYSIS AND DATA ENRICHMENT USING KNOWLEDGE SOURCES”; and U.S. Pat. No. 10,565,222, titled “TECHNIQUES FOR FACILITATING THE JOINING OF DATASETS”; each of which above-referenced patents, together with the contents thereof, are herein incorporated by reference.

### Large Language Models (LLM)

In accordance with an embodiment, the systems and methods described herein can utilize a large learning model (LLM) in order to perform functions such as, creating enrichment and transformation scripts, which can be utilized by the user or additional users with respect to selected data tables or datasets.

In accordance with an embodiment, the systems and methods can provide a feature to train an LLM model with the existing metadata in a user's database (e.g., RCU DB), which could streamline a process by avoiding/negating a dataprep call. As new objects may be routinely added to a database, frequent/consistent training of an LLM can be provided.

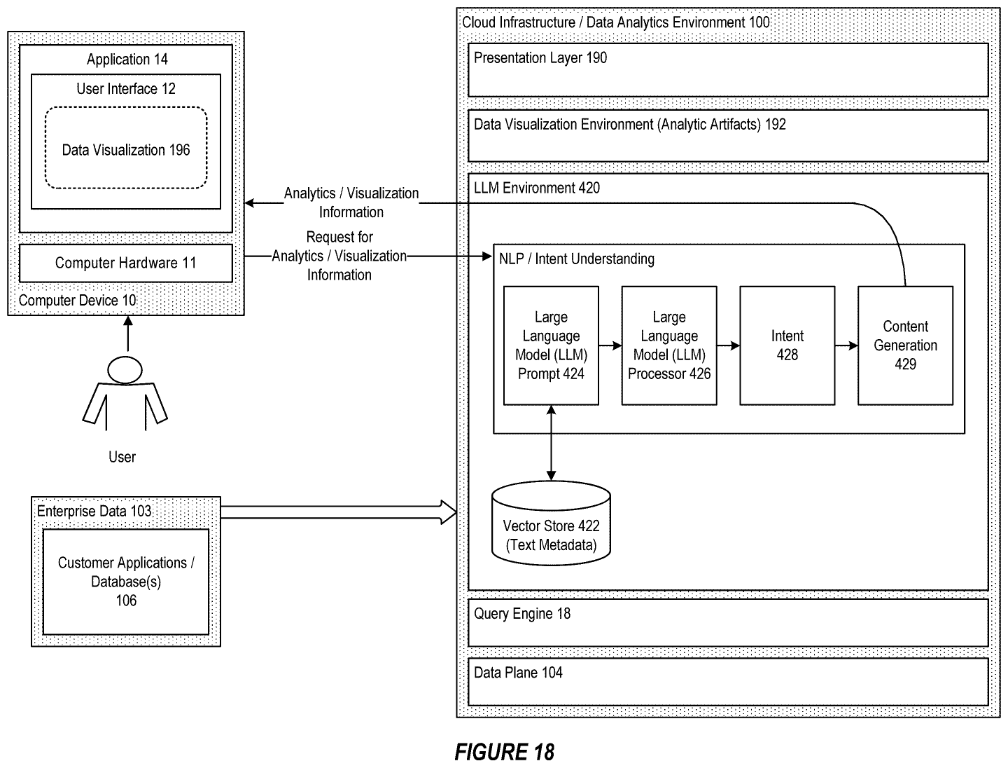

FIG. 18 further illustrates an example data analytics environment, including the use of a large language model, in accordance with an embodiment.

As illustrated in FIG. 18, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

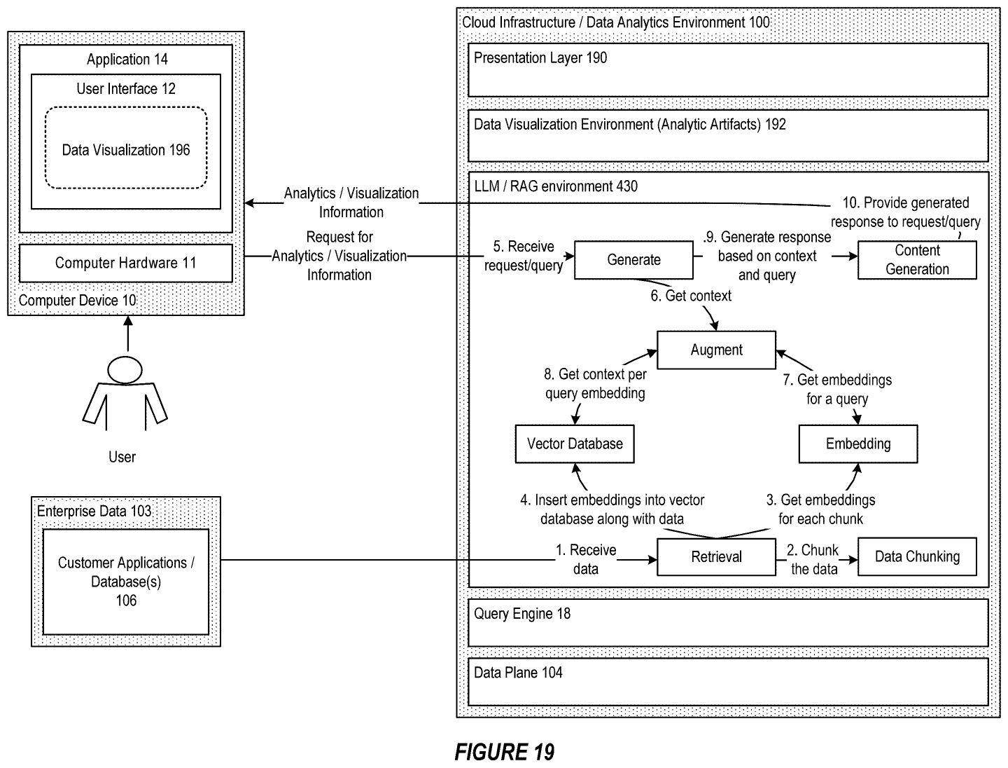

FIG. 19 further illustrates an example data analytics environment, including the use of retrieval-augmented generation, in accordance with an embodiment.

As illustrated in FIG. 19, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process::
Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

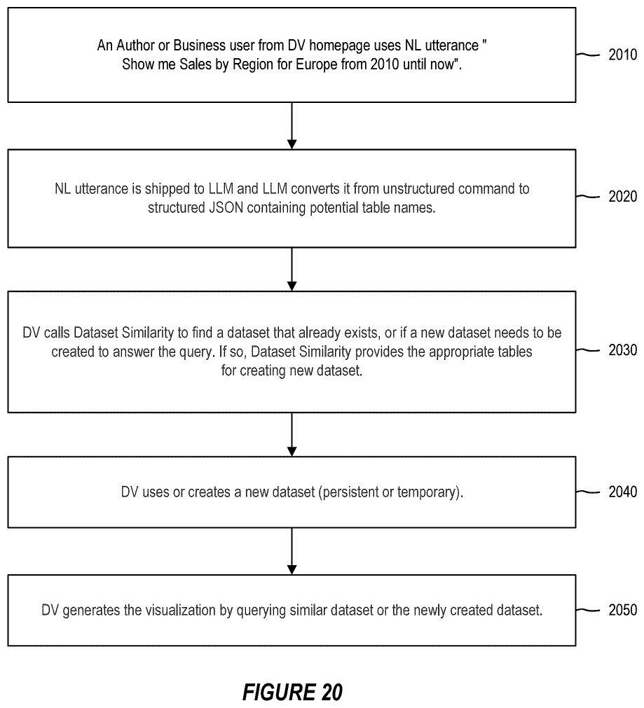

FIG. 20 illustrates a flowchart of a method for use with a data analytics environment to provide a data modeling assistant for use with the data analytics environment, in accordance with an embodiment.

In accordance with an embodiment, at 2010, an author or user (e.g., a business user) can utilize a natural language phrase/input/utterance at a data visualization homepage. For example, a natural language utterance could comprise: “Show me sales numbers by region for Europe from 2010 until now.”

In accordance with an embodiment, at 2020, the natural language phrase/input/utterance can be shipped to an LLM, where the LLM can convert it from an unstructured command to a structured format, such as JSON, which can comprise potential table names.

In accordance with an embodiment, at 2030, the data visualization environment can determine a dataset similarity to find a dataset that is similar and already exists (and provide the similar dataset), or determine if a new dataset should be created to answer the posed query. If so determined that a new dataset should be created, the dataset similarity can provide appropriate tables for creating a new dataset.

In accordance with an embodiment, at 2040, the data visualization environment can use or create a new dataset (persistent or temporary).

In accordance with an embodiment, at 2050, the data visualization environment can generate the visualization by querying the provided similar dataset, or querying the newly created dataset.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to provide a data modeling assistant for use with the data analytics environment, comprising:
a computer including one or more processors, that provides access to a data analytics environment;
wherein the data analytics environment receives an instruction to ingest a first dataset, the first data set being retrieved from a computing device or from a storage accessible by the data analytics environment;
wherein the data analytics environment, during ingestion of the first dataset, semantically profiles the first dataset to generate a set of metrics and metadata associated with the first dataset;
wherein the data analytics environment, based upon a comparison of the generated set of metrics and metadata associated with the first dataset with a plurality of pre-existing datasets, generates a recommendation for the first dataset.

2. The system of claim 1, wherein the generated recommendation comprises a dataset duplication recommendation.

3. The system of claim 2, wherein the dataset duplication recommendation is generated based upon the comparison of the generated set of metrics and metadata associated with the first dataset with a plurality of pre-existing datasets resulting in at least a partial match with one of the plurality of pre-existing datasets; and
wherein the dataset duplication recommendation presents an option to utilize the one of the plurality of pre-existing datasets instead of the first dataset.

4. The system of claim 3, wherein, based upon a security level communicated by the computing device, a name associated with the one of the plurality of pre-existing datasets is obfuscated from the computing device.

5. The system of claim 1, wherein the generated recommendation comprises a dataset join recommendation;
wherein the dataset join recommendation is generated based upon the comparison of the generated set of metrics and metadata associated with the first dataset with a plurality of pre-existing datasets resulting in determining one or more tables of one of the plurality of pre-existing datasets having a similarity score exceeding a threshold value.

6. The system of claim 5, wherein the dataset join recommendation presents an option to join one or more columns of the one of the plurality of pre-existing datasets with the first dataset within a canvas of the data analytics environment.

7. The system of claim 1, wherein, based upon a security level communicated by the computing device, a name associated with the one of the plurality of pre-existing datasets is obfuscated from the computing device.

8. A method for use with a data analytics environment to provide a data modeling assistant for use with the data analytics environment, comprising:
providing, by a computer including one or more processors, access to a data analytics environment;
receiving, at the data analytics environment, an instruction to ingest a first dataset, the first data set being retrieved from a computing device or from a storage accessible by the data analytics environment;
semantically profiling, during the ingestion of the first dataset by the data analytics environment, the first dataset to generate a set of metrics and metadata associated with the first dataset;
based upon a comparison of the generated set of metrics and metadata associated with the first dataset with a plurality of pre-existing datasets, generating, by the data analytics environment, a recommendation for the first dataset.

9. The method of claim 8, wherein the generated recommendation comprises a dataset duplication recommendation.

10. The method of claim 9, wherein the dataset duplication recommendation is generated based upon the comparison of the generated set of metrics and metadata associated with the first dataset with a plurality of pre-existing datasets resulting in at least a partial match with one of the plurality of pre-existing datasets; and
wherein the dataset duplication recommendation presents an option to utilize the one of the plurality of pre-existing datasets instead of the first dataset.

11. The method of claim 10, wherein, based upon a security level communicated by the computing device, a name associated with the one of the plurality of pre-existing datasets is obfuscated from the computing device.

12. The method of claim 8, wherein the generated recommendation comprises a dataset join recommendation;
wherein the dataset join recommendation is generated based upon the comparison of the generated set of metrics and metadata associated with the first dataset with a plurality of pre-existing datasets resulting in determining one or more tables of one of the plurality of pre-existing datasets having a similarity score exceeding a threshold value.

13. The method of claim 12, wherein the dataset join recommendation presents an option to join one or more columns of the one of the plurality of pre-existing datasets with the first dataset within a canvas of the data analytics environment.

14. The method of claim 8, wherein, based upon a security level communicated by the computing device, a name associated with the one of the plurality of pre-existing datasets is obfuscated from the computing device.

15. A non-transitory computer readable storage medium having instructions thereon for use with a data analytics environment to provide a data modeling assistant for use with the data analytics environment, which when read and executed cause a computer to perform steps comprising:
providing, by the computer, the computer including one or more processors, access to a data analytics environment;
receiving, at the data analytics environment, an instruction to ingest a first dataset, the first data set being retrieved from a computing device or from a storage accessible by the data analytics environment;
semantically profiling, during the ingestion of the first dataset by the data analytics environment, the first dataset to generate a set of metrics and metadata associated with the first dataset;
based upon a comparison of the generated set of metrics and metadata associated with the first dataset with a plurality of pre-existing datasets, generating, by the data analytics environment, a recommendation for the first dataset.

16. The non-transitory computer readable storage medium of claim 15, wherein the generated recommendation comprises a dataset duplication recommendation.

17. The non-transitory computer readable storage medium of claim 16, wherein the dataset duplication recommendation is generated based upon the comparison of the generated set of metrics and metadata associated with the first dataset with a plurality of pre-existing datasets resulting in at least a partial match with one of the plurality of pre-existing datasets; and
wherein the dataset duplication recommendation presents an option to utilize the one of the plurality of pre-existing datasets instead of the first dataset.

18. The non-transitory computer readable storage medium of claim 17, wherein, based upon a security level communicated by the computing device, a name associated with the one of the plurality of pre-existing datasets is obfuscated from the computing device.

19. The non-transitory computer readable storage medium of claim 15, wherein the generated recommendation comprises a dataset join recommendation;
wherein the dataset join recommendation is generated based upon the comparison of the generated set of metrics and metadata associated with the first dataset with a plurality of pre-existing datasets resulting in determining one or more tables of one of the plurality of pre-existing datasets having a similarity score exceeding a threshold value.

20. The non-transitory computer readable storage medium of claim 19, wherein the dataset join recommendation presents an option to join one or more columns of the one of the plurality of pre-existing datasets with the first dataset within a canvas of the data analytics environment.
